(19) United States
(12) Patent Application Publication
(10) Pub. No.: US 2008/0077456 A1
(43) Pub. Date: Mar. 27, 2008

(54) BOAT RENTAL SYSTEM

(76) Inventor: Derrick Meer, Orlando, FL (US)

Correspondence Address: KELLEY DRYE & WARREN LLP, 400 ALTLANTIC STREET , 13TH FLOOR, STAMFORD, CT, 06901, US

(21) Appl. No.: 11/858,295

(22) Filed: Sep. 20, 2007

Related U.S. Application Data
(60) Provisional application No. 60/846,582, filed on Sep. 22, 2006.

(51) Int. Cl. G06Q 10/00

(52) U.S. Cl. 705/5

(57) ABSTRACT

A method of renting boats wherein the boat is dropped off in a boat-trailer combination for towing by a renter.

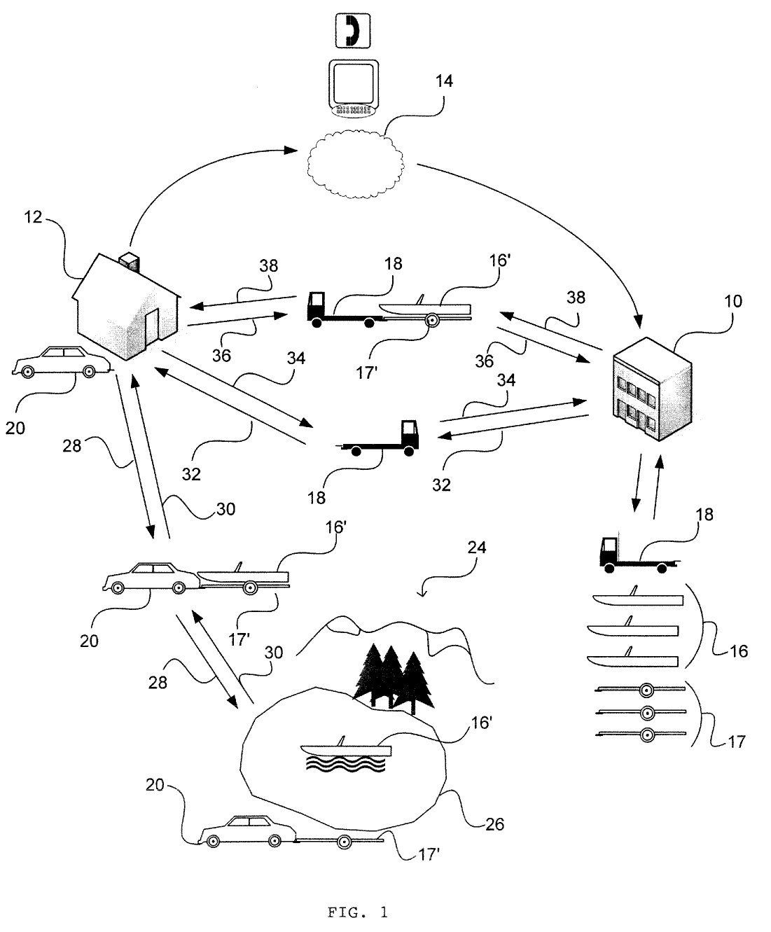

### CROSS-REFERENCE TO RELATED APPLICATIONS

This U.S. Non-Provisional Application claims benefit of U.S. Provisional Application No. 60/846,582, filed on Sep. 22, 2006, the disclosure of which is herein incorporated by reference in its entirety.

### BACKGROUND OF THE INVENTION

All references cited in this specification, and their references, are incorporated by reference herein where appropriate for teachings of additional or alternative details, features, and/or technical background.

1. Field of the Invention

The present invention generally relates to a boat rental system and method wherein a customer reserves a boat via online or telecommunications reservations, and the boat is delivered to the customer at a specified site, which may be the customer's residence, on a trailer allowing the customer to trailer the boat to a desired launch site.

2. Description of the Related Art

Numerous people enjoy the experience of boating on bodies of water such as the ocean, lakes and rivers. Some people charter boats for the thrill of the boat itself propelling in the water, others for sports-related activities, such as water skiing, and others for a mode to reach desired locations and to be used as a stationary platform for other activities such as fishing, snorkeling, or diving.

Boat rental services are offered by numerous marina operations. Typically a boat is rented for use from the particular marina in which the boat rental service resides. The renter may be limited to using the boat within a specified area within a perimeter of the marina or given a mileage allowance which if passed causes the rental fees to increase.

Other rental services allow for pick-up of a boat at one of a plurality of specified marinas in which the rental service keeps rental boats in numerous slips. This offers the customer a greater selection of locations in which the customer may wish to expend time in his or her boating adventure.

A third approach, that is typically used by small boat (such as, for example, canoes) rental companies, is a private-hauling boat rental system wherein boats are stored and/or moored at one central location and private owners are allowed to trailer the boats from the central location to where a preferred launch site has a public or private access ramp. In such an approach, customers are provided the ability to trailer the boat of their choice from the boat fleet to these places like a private boat owner may do. Like private owners, customers can also trailer their boats long distances, e.g., distances that would be too burdensome to travel by boat from a marina-based rental company.

The boat rental company may be a private or public commercial entity or an association such as a boating club. Boating clubs generally maintain boats in slips so that they are fully functional when needed. They also manage reservations for use of these boats. Membership in the boat club is typically limited to persons demonstrating a threshold of boating expertise and the ability of the person to pay a lump sum upfront fee to become a part owner of the boats in the club and some monetary scheduled payments thereafter in order to keep the club in business.

The problem with such marina-based boat rental systems is that they allow for a boating experience in only fixed locations within a set distance about the marina. Examples of such fixed location, marina-based models include, without limitation, Freedom Boat Club, Legacy Boat Club and Club Nautico. As marinas are not typically located on lakes, rivers and intercostals, the type of body of water on which the boating adventure may be experienced is also limited. Boat clubs suffer from many of the same disadvantages as marina-based private or public commercial boat rental entities. The problem with small boat central storage rental systems is that such systems require that the customer drive to the rental location and pick up (and later drop off) the boat. Such systems require the customer to expend considerable time, thereby affecting the overall boating experience.

Given prior art boat rental systems and their attendant disadvantages, there is a need for improved boat reservation and maintenance systems and methods.

### SUMMARY OF THE INVENTION

There are provided herein methods and systems for renting boats to consumers.

In one embodiment, there is provided a method of renting boats comprising: receiving a request for a particular boat from a consumer at a first location; moving the boat on a trailer from the first location to a drop-off location wherein the consumer has indicated there will be a vehicle with a trailer hitch; allowing the consumer to tow the vessel with such vehicle to a slipping location allowing access to their choice of a body of water; picking-up the boat from the consumer from the drop-off location at a defined time after drop-off, processing the picked up boat in a manner to allow for its future use by other consumers. Preferably the trailer hitch on the vehicle and the trailer carrying the boat have corresponding structure to allow the trailer to be safely and securely attached to the trailer hitch to allow the vehicle to move the boat to the desired slipping location. In one aspect, the first location is one of a marina-based boat rental company, a private-hauling boat rental company, and a boat club. A second location may include, for example, a consumer's primary or secondary place of residence, or a central drop-off location accessible to the consumer. The body of water may comprise any type of water retention area which is large enough to allow the boat to float thereon, including, for example, a lake, a pond, the ocean, a river, a canal, and a channel. The defined time for pick-up after drop-off may be predetermined by any rental agreement between the person dropping off the boat and the consumer, or may be at a time after the consumer notifies the first location that the boat will be found at the drop-off location or at the end of the term of the reservation date(s). The boat and/or trailer which is delivered may be wholly-owed by the entity dropping off the boat, or may be partially or wholly owned by the consumer seeking the boat.

### BRIEF DESCRIPTIONS OF DRAWINGS

The FIGURE illustrates in diagrammatic form an exemplary boat rental method of the present invention.

### DETAILED DESCRIPTION OF THE INVENTION

Traditional boat ownership, marina-based boat clubs and boat rental companies can be said to not provide the degree of convenience, choice and availability which many boaters desire. For example, marina-based boat clubs and boat rental companies typically allow for only a limited boating experience based on the location wherein the boat is moored for rental. While boat ownership can be said to overcome the problem of limited venues of use for the boat renter, ownership typically involves laboring efforts and significant costs being expended by the owner to keep the boat ready for use. Unless a person owns a large number of boats, ownership also typically does not lend the ability of a person to match the desired boating experience with the type of boat most suited for such experience. For example, ownership of a sailboat does not allow for water skiing.

There are provided herein new methods and systems for improving the match between the boat and water experience desired to allow the boater a wide range of water locations to be visited with the chosen boat, and to provide the boater improved convenience in obtaining and returning the boat used in the water experience.

In one embodiment, there is provided a boat delivery and pick-up method. In such method, a boat rental company or boat club, etc., allows a consumer to obtain a boat by requesting the same via a mode of communication, such as by a computer over a widely disseminated network, telephone, cell phone, Blackberry, personal data assistant, etc. After approval of a form of credit or pecuniary remuneration, the boat is delivered to the consumer at a specified consumer location, such as the consumer's residence, a centrally located storage facility or a central location on a trailer, and the boat-trailer combination is left with the consumer for the consumer's use. The consumer is then allowed to move the boat to where the water experience is to occur. In such embodiment, the consumer then returns with the boat to the specified consumer location. The boat rental company, etc., then picks up the boat-trailer combination and returns it to the rental location. Pick-up at the specified consumer location may be activated by consumer communication with the boat rental company, etc., or may be at a predetermined time as agreed upon by the consumer and boat rental company, etc.

As would be understood, such method is particularly useful in the context of a boat club, wherein each member can have a personal vehicle affixed with the appropriate tow gear for moving the trailers provided with boats which the boat club proffers. The boat rental company, boat club, etc., may own the boat and trailer assets outright or consumers of such services may have ownership rights therein as well.

Such process allows boaters more choice in that they get to select the lake, intercostals, ocean, rivers, etc., on which they desire to have the boating experience. By trailering the boat, consumers get to choose their boating adventures.

Turning now to the FIGURE, there is shown an illustration of a boat-trailering method of the present invention. As illustrated, the consumer contacts boat rental company 10 from consumer's residence 12 via a mode of communication 14 such as telephone or internet connection specifying the type of boat which is desired to be rented. Boat rental company 10 then selects from its boat inventory 16 boat 16′ which matches the consumer's request and places the boat on an appropriate trailer 17′ selected from its trailer inventory 17. Using company vehicle 18, the rental company delivers 38 boat-trailer combination 16′-17′ via vehicle 18 to consumer's residence 12 (vehicle 18 returning 34 to rental company 10 without boat-trailer combination 16′-17′). The consumer then is allowed to move boat-trailer combination 16′-17′ by means of a consumer mobile 20 by hitching trailer 17′ to mobile 20 as shown at 22. After travel 28 to desired destination 24, the consumer can unhitch boat 16′ from trailer 17′ and place boat 16′ in desired body of water 26. After the boating experience is completed, the consumer recombines trailer 17′, and boat 16′ then travels back 30 to consumer's residence 12 via mobile 20. Boat-trailer combination 16′-17′ is then left at consumer's residence 12. The combination is then picked up at consumer's residence 12 by rental company 10 using company vehicle 18 or other suitable vehicle. Vehicle 18 is driven 32 to consumer's residence 12, boat-trailer combination 16′-17′ is hitched thereon and the combination and vehicle driven back 36 to rental company 10.

### STATEMENT REGARDING PREFERRED EMBODIMENTS

While the invention has been described with respect to the foregoing, those skilled in the art will readily appreciate that various changes and/or modifications can be made to the invention without departing from the spirit or scope of the invention as defined by the appended claims.

What is claimed is:

1. A method of renting boats comprising:
receiving a request for rental of a particular boat from a consumer at a first location;
moving the boat on a trailer from the first location to a drop-off location wherein the consumer has indicated there will be a vehicle with a trailer hitch;
allowing the consumer to tow the boat-trailer combination with such vehicle having a trailer hitch to a slipping location remote to the drop-of location, thereby allowing access to the consumer's choice of a body of water;
picking up the boat-trailer combination at the drop-off location at a defined time after drop-off;
processing the picked up boat in a manner to allow for its future use by other consumers.

2. The method of claim 1 wherein the second location is the consumer's primary or secondary place of residence.

3. The method of claim 1 wherein the second location is a central drop-off location accessible to the consumer.

4. The method of claim 1 wherein the body of water is selected from at least one of a water retention area, lake, pond, ocean, river, canal and channel.

5. The method of claim 1 wherein the defined time for pick-up after drop-off is predetermined by any rental agreement between the entity dropping off the boat and the consumer.

6. The method of claim 1 wherein the defined time for pick-up after drop-off is determined by consumer notification from the first location that the boat has been left at the drop-off location.

7. The method of claim 1 wherein the boat and/or trailer are wholly-owed by the entity dropping of the boat-trailer combination.

8. The method of claim 1 wherein the boat and/or trailer are partially-owned by the consumer.

9. The method of claim 1 wherein the boat reservation allows consumers to request equipment (i.e., water skis, snorkels, fishing) and services (i.e., food, ice) on the boat when the vessel is delivered to the pick-up location.
